(19) United States
(12) Patent Application Publication
(10) Pub. No.: US 2009/0081614 A1
(43) Pub. Date: Mar. 26, 2009

(54) Orthodontic implant system

(76) Inventors: Rolf Forster, Pforzheim (DE); Bjorn Ludwig, Traben-Trarbach (DE)

Correspondence Address: WALTER A. HACKLER, Ph.D.;PATENT LAW OFFICE, 2372 S.E. BRISTOL STREET, SUITE B, NEWPORT BEACH, CA, 92660-0755, US

(21) Appl. No.: 12/283,534

(22) Filed: Sep. 12, 2008

(30) Foreign Application Priority Data
Sep. 21, 2007 (DE) DE102007045199.9

(51) Int. Cl. A61C 8/00

(52) U.S. Cl. 433/174

(57) ABSTRACT

Herein is described an orthodontic implant system with a screw implant of elongated body with a first section that is provided with a thread for the anchoring in a jawbone and a second section for protruding from the jawbone and a detachable head to be joined to the screw implant. The head has a recess for slipping onto the second section of the screw implant.

The invention relates to an orthodontic implant system with the features set forth in the preamble of claim 1. Such an implant system is known from DE 196 22 668 A1.

The treatment of teeth malpositionings is usually carried out by means of an orthodontic wire that exercises a correcting force on the malpositioned teeth. A therewith connected counterforce can be absorbed by other teeth. However, due to the counterforce it is possible that correctly positioned teeth are subject to an undesired displacement. It can also happen that a patient is missing teeth and that, because of this, there are no appropriate teeth for the absorption of the counterforce.

Thus, from prior art are known orthodontic implant systems that are anchored in a jawbone for the treatment of malpositioned teeth, absorbing as abutments the counterforce generated with the correction of teeth malpositionings.

Two-part implant systems, in which a screw implant anchored in the jawbone has a removable head, have the advantage that, being especially flexible, they can be used in several treatment phases. By way of example, upon conclusion of the first treatment phase, the head can be removed should it no longer be necessary for the fastening of the archwire. At first, the screw implant can remain in the jawbone and, in case of need, be provided anew with a head in subsequent treatment phases.

### SUMMARY OF THE INVENTION

The object of the invention is to provide a manner in which the job of the orthodontists can be made easier by means of multipart implant systems.

This object is attained by an orthodontic implant system with the features set forth in claim 1. Further advantageous embodiments of the invention are subject-matter of the dependent claims. This object is also attained by a head to be joined to a screw implant according to claim 15.

The head of an implant system according to the invention is provided with a recess for the joining to the second section of the screw implant which, pursuant to specifications, protrudes from the jawbone. The slipping of a head onto a screw implant can be obtained easier and faster than with the screwing in of the head into an internal screw thread of the screw implant as disclosed by DE 196 22 688 A1.

An important advantage of an implant system according to the invention is also that various appliances such as, e.g., arms of palatal expansion screws or of bracing wire can be attached to it in an orthodontic laboratory, be it by soldering or welding. Such type of work cannot be done in the mouth.

By way of example, by using a plaster model, in an orthodontic laboratory it can be studied how and where the required parts for an orthodontic treatment are to be used. In such instances it is especially advantageous that, at first, the orthodontist inserts the screw implant into the jawbone and then by using an impression, the laboratory works out and prepares the devices required for the treatment. The appliances and parts of the devices can be already affixed in the laboratory to the head that is to be joined later to the screw implant so that the time the patient must spend in the orthodontist's chair can be substantially reduced.

The head can be provided with an opening in a lateral wall. Such an opening forms a passage to the recess for the passing through of a retaining means such as, e.g., a wire, pins, lamellas or a filling compound into or from the recess. In such a manner, the head can be joined in a detachable manner with wire to the screw implant. By way of example, the screw implant can be provided transversally to its longitudinal direction with a borehole through which is inserted a wire that passes through the opening, joining thus in a detachable manner the head to the screw implant. It is also possible to effectuate a wire ligature around the screw implant. In such a case, it is advantageous to provide the screw implant with an undercut in order to prevent an axial movement of the wire ligature towards the end of the screw implant protruding from the bone. It is especially advantageous to configure such an undercut of the screw implant as an annular groove in order to secure a wire ligature in an especially reliable manner.

The surface of the recess of the head can be provided with either one only opening or also with several opening such as, e.g., opposite boreholes. Preferred is the at least one opening is configured as a notch, that is to say as an oblong opening extending in the circumferential direction. Such an opening can be milled, for example.

In order to prevent that, while making a denture impression, impression compound enters into the recess, an implant system in accordance with the invention preferably comprises at least two heads, of which a first head, not provided with an opening, is used for the making of an impression while a second head of the same dimensions, provided with at least one opening, is intended for the actual treatment.

### BRIEF DESCRIPTION OF THE DRAWINGS

Other details and advantages of the invention are explained by way of an embodiment with reference to the accompanying drawings. The therein described features can be made object of the claims either individually or in a combination of same, wherein:

FIG. 1 shows an embodiment of an implant system according to the invention with the head joined to on the screw implant;

FIG. 2 shows the screw implant with removed head;

FIG. 3 shows another view of the screw implant with removed head;

FIG. 4 shows another view of the crew implant with removed head;

FIG. 5 shows a lateral view of the screw implant with joined head;

FIG. 6 shows a cross-section of FIG. 5 along the line BB; and

FIG. 7 shows a longitudinal section of FIG. 5.

### DETAILED DESCRIPTION

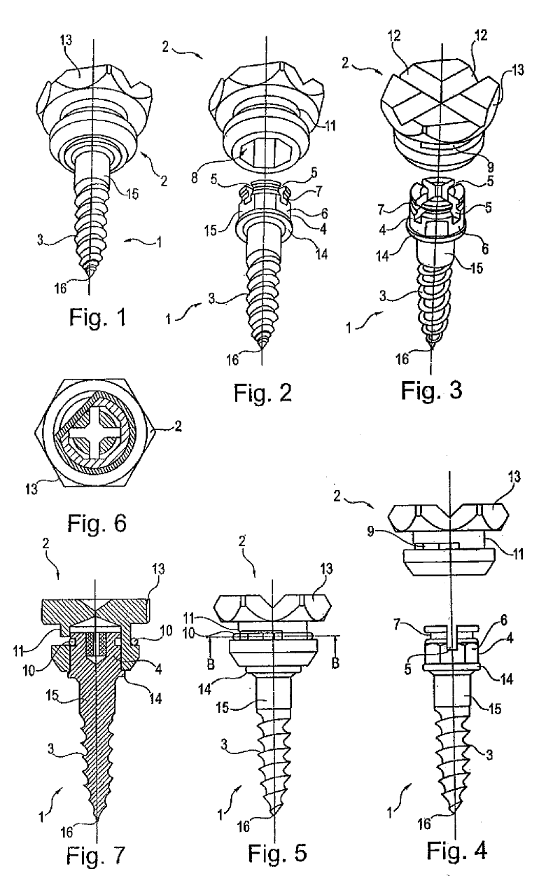

FIGS. 1 to 5 illustrate in various views an embodiment of a multipart orthodontic implant system. The implant system comprises as a first part a screw implant 1 and as a second part a head 2 to be joined to the screw implant 1.

The crew implant 1 has an elongated body with a first section 3 provided with a thread for the anchoring into a jawbone and a second section 4 for protruding from the jawbone. The second section 4 is provided with an external polygon 6, e.g., an external octagon.

The head 2 to be joined to the screw implant is provided with a recess 8 for slipping onto the screw implant 1. In the illustrated embodiment the recess 8 is a blind hole. The external polygon 6 of the screw implant fits into the recess 8 which is configured in a matching multi-sided manner so that a joined head 2 is not rotatable with respect to the screw implant 1. In the illustrated embodiment the external polygon of the second section is an external octagon and recess 8 is provided with an inside octagon

The second section 4 of the screw implant 1 is provided at one of its end faces with two cross-shaped slits 5 for the inserting of a wire spring. The second section is further provided with an annular groove 7 for the inserting of a wire spring that is preferably breached by the slits 5. A wire spring can be fastened to the screw implant 1 by means of the slits 5 and/or the annular groove 7. Therefore, the screw implant can be used for orthodontic treatment also without the detachable head 2, e.g., by using it for the anchoring of bracing wire.

The head 2 is provided on one of the surfaces of the recess 8 with an opening 9 for the inserting of a wire. Said opening is preferably a slit but, in principle, it can also be configured as a borehole extending transversally to the direction into which the head 2 is joined to the screw implant 1. The slit is provided as cut extending transverse to the direction in which the head 2 is slipped onto the head 2. Such a slit can be produced by milling, for example.

With the head 2 joined to the screw implant 1, the opening 9 is above the annular groove. With the head 2 joined to the screw implant, the opening 9 and the annular groove 7 can be at the same distance from the end of the screw implant 1 anchored in the jawbone. It is however, preferable that the opening 9 is somewhat offset with respect to the annular groove 7 in order to generate a prestressing in a wire ligature that is inserted in the annular groove 7 and passes through the opening 9. With the head 2 joined to the screw implant 1, it is especially preferred that the displacement between the opening 9 and the annular groove 7 is between one fourth and three fourths of the width of the annular groove 7, in particular, between one third and two thirds.

For the joining of the head 2 to the screw implant 1 it is possible to place a wire ligature into the annular groove 7 and passing it through the opening 9. By way of example, such a wire ligature is illustrated in FIG. 5. Should it become necessary to remove the head 2 from the screw implant 1 it can be easily accomplished, e.g., by cutting through the wire 10 protruding from the opening 9.

FIG. 6 shows a cross-section of FIG. 5 along the line BB; FIG. 7 shows a longitudinal view of FIG. 5 in which can also be seen the wire ligature 10.

The opening 9 is preferably provided in an annular groove 11 so that wire ligature passing through the opening 9 can also be guided on the outside of the head 2.

The head 2 has an end face with two intersecting grooves 12 that have preferably a V-shaped cross-section. However, one or several grooves with an arched cross-section are also possible. Arms of palatal expansion screws, anchoring elements, other screws, or wire springs can be fastened by welding or soldering. In such a manner, a head 2 can be prepared in an orthodontic laboratory for an orthodontic treatment by effectuating welding or soldering operations that would not be possible in the mouth.

The head 2 is provided with an external polygon 13, e.g., an external hexagon. It is easier to apply a wrench on the larger external polygon 13 than on the smaller external polygon 6 of the screw implant 1. Thus, by joining the head 2 to the screw implant 1 the screwing or unscrewing of the implant is easier.

As shown in the illustrations, a collar 14 abuts the external hexagon 6 of the screw implant to which is joined the head 2. A smooth cylindrical shaft 15 abuts the collar 14. The shaft 15 abuts the external thread of the second section 3 that ends in a tip 16.

The external thread is a single-flight, self-grooving thread, the flanks of which or thread grooves, respectively, have an asymmetric profile. Alternatively, a multiple thread can also be provided.

### REFERENCE NUMBERS LIST

1 Screw implant

2 Head

3 First section

4 Second section

5 Slits

6 External polygon

7 Annular groove

8 Recess

9 Opening

10 Wire

11 Annular groove

12 Grooves

13 External polygon

14 Collar

15 Shaft

16 Tip

What is claimed is:

1. An orthodontic implant system comprising
a screw implant that has an elongated body with a first section which is provided with a thread for the anchoring into a jawbone, a second section for protruding from the jawbone, and
a detachable head with a recess for slipping onto the second section of the screw implant, wherein
a lateral wall of the head is provided with an opening providing a passage to the recess.

2. An implant system according to claim 1, wherein the recess is a blind hole.

3. An implant system according to claim 1, wherein the second section of the screw implant has a polygonal cross-section, and the recess of the head is configured in a matching multi-sided manner.

4. An implant system according to claim 3, wherein the second section of the screw implant has an octagonal cross-section and the recess of the head is configured in a matching multi-sided manner.

5. An implant system according to claim 1, wherein the second section of the screw implant is provided with an undercut.

6. An implant system according to claim 5, wherein the undercut is a groove.

7. An implant system according to claims 1, wherein the opening is positioned at least partly above the annular groove when the head is joined to the screw implant.

8. An implant system according to claim 1, wherein the opening is a slit.

9. An implant system according to claim 1, wherein the opening is provided in an annular groove.

10. An implant system according to claim 1, wherein the head has an end face with one or several grooves.

11. An implant system according to claim 1, wherein the head has an end face with two intersecting grooves.

12. An implant system according to claim 11, wherein the grooves have a V-shaped cross-section.

13. An implant system according to claim 1, wherein the head is provided with an external polygon.

14. An implant system according to claim 1, comprising at two heads of which only one has an opening in a lateral wall.

15. An implant system according to claim 1 further comprising a head with a recess for slipping onto a screw implant.

16. An orthodontic implant system comprising
a screw implant that has an elongated body with a first section which is provided with a thread for the anchoring into a jawbone, a second section for protruding from the jawbone, and
a detachable head for joining to the screw implant,
wherein the head is provided with a recess for slipping onto the second section of the screw implant.
